(19) United States
(12) Patent Application Publication
(10) Pub. No.: US 2011/0270711 A1
(43) Pub. Date: Nov. 3, 2011

(54) MANAGING APPLICATION INTERACTIONS WITH ENTERPRISE SYSTEMS

(75) Inventor: Stefan Wilhelm Kusterer, Malsch (DE)

(73) Assignee: SAP AG, Walldorf (DE)

(21) Appl. No.: 12/971,501

(22) Filed: Dec. 17, 2010

Related U.S. Application Data
(60) Provisional application No. 61/328,803, filed on Apr. 28, 2010.
(60) Provisional application No. 61/328,822, filed on Apr. 28, 2010.

(51) Int. Cl. G06Q 30/00; G06F 15/16; G06F 21/00

(52) U.S. Cl. 705/27.1; 726/11; 709/246; 709/217; 705/34

(57) ABSTRACT

Networked services may interface with enterprise systems of an organization to access data in the enterprise systems. A networked service may be able to retrieve, manipulate, and store data in the enterprise systems. Once a networked service interfacing with enterprise systems has been created, developers may create apps or applications that call one or more networked services to access data in the enterprise systems. The apps may provide basic functionality, such as generating a user interface in a specific device using a specific industry standard platform for incorporating data from enterprise systems accessed by a linked service. Networked services may also contain modules for tracking calls or invocations of the service together with an identifier of an associated application and user, in addition to other data. This data may be recorded in a database and shared to compensate parties based on actual usage of the services and/or apps.

### REFERENCE OF RELATED APPLICATIONS

This application claims the benefit of U.S. Provisional Application Nos. 61/328,803 and 61/328,822 filed on Apr. 28, 2010, hereby incorporated by reference.

### BACKGROUND

Many organizations rely on computing systems such as enterprise resource planning (ERP) or customer relationship management (CRM) systems to electronically manage business processes and functions.

It is usually only possible for enterprise-internal users to interact with these enterprise systems. While in many situations it is desirable to also allow enterprise-external users to interact with these systems, this interactivity is often not provided because of a lack of a secure means for accessing the internal enterprise systems. In addition, it is also unclear how the enterprise and/or external users can be charged for this usage pattern by the vendor of the applications running enterprise systems.

Instead of waiting for new features and capabilities to be introduced by a manufacturer in a new release or system upgrade, many businesses would like to quickly deploy new applications and interfaces for interacting with data stored in these systems without having to wait for the manufacturer's periodic releases and upgrades.

Additionally, many software developers would like to develop new applications and interfaces for interacting with the organization's data, but are often limited by proprietary platforms and protocols used by organizational computing systems. For example, software developers familiar with coding platforms and protocols for certain mobile devices may be able to quickly and efficiently develop new applications for the mobile devices but they may not be able to develop applications for those devices that interface with the organizational computing systems because they are not familiar with the protocols and technologies used by those systems.

Software developers may also not be willing to invest resources in developing new applications that interface with data in organizational systems if they do not have sufficient incentives to encourage the initial resource investment. Similarly, organizations may not want to invest financial resources for software development resulting in unwanted or unused applications.

There is thus a need for an approach that allows developers to build new applications based on industry standard platforms and protocols that can interface with organization computing systems. There is also a need for a compensation model to compensate developers creating new applications based on the actual usage of their application.

### BRIEF DESCRIPTION OF THE DRAWINGS

FIG. 1 shows exemplary interactions between networked applications and networked services in an embodiment of the invention.

FIG. 2 shows an exemplary deployment and distribution plan in an embodiment.

FIG. 3 shows an exemplary monetization plan in an embodiment.

FIG. 4 shows an exemplary method in an embodiment.

FIG. 5 shows an exemplary flow of data between systems in an embodiment.

FIG. 6 shows an exemplary architecture of systems in an embodiment of the invention.

### DETAILED DESCRIPTION

In an embodiment of the invention, one or more networked services may interface with enterprise systems of an organization to access data in the enterprise systems. Each networked service may restructure queries, filters, functions, operations, fields, or classes from a standardized protocol to one recognized by the organizational software and system. In this regard, a networked service may be able to retrieve, manipulate, and store data in the enterprise systems.

Once a networked service interfacing with enterprise systems has been created, developers or other third parties may create apps or applications that call one or more networked services to access data in the enterprise systems. The apps may provide basic functionality, such as generating a user interface in a specific device using a specific industry standard platform and then incorporating data from enterprise systems accessed and/or manipulated by a linked service.

Networked services may also contain modules for tracking calls or invocations of the service together with an identifier of an associated application and user, in addition to other data. This data may be recorded in a database and shared with the creators of apps and/or networked services, among others, to compensate parties based on actual usage of the services and/or apps. The recorded usage data may also be used to monitor usage of services and/or apps.

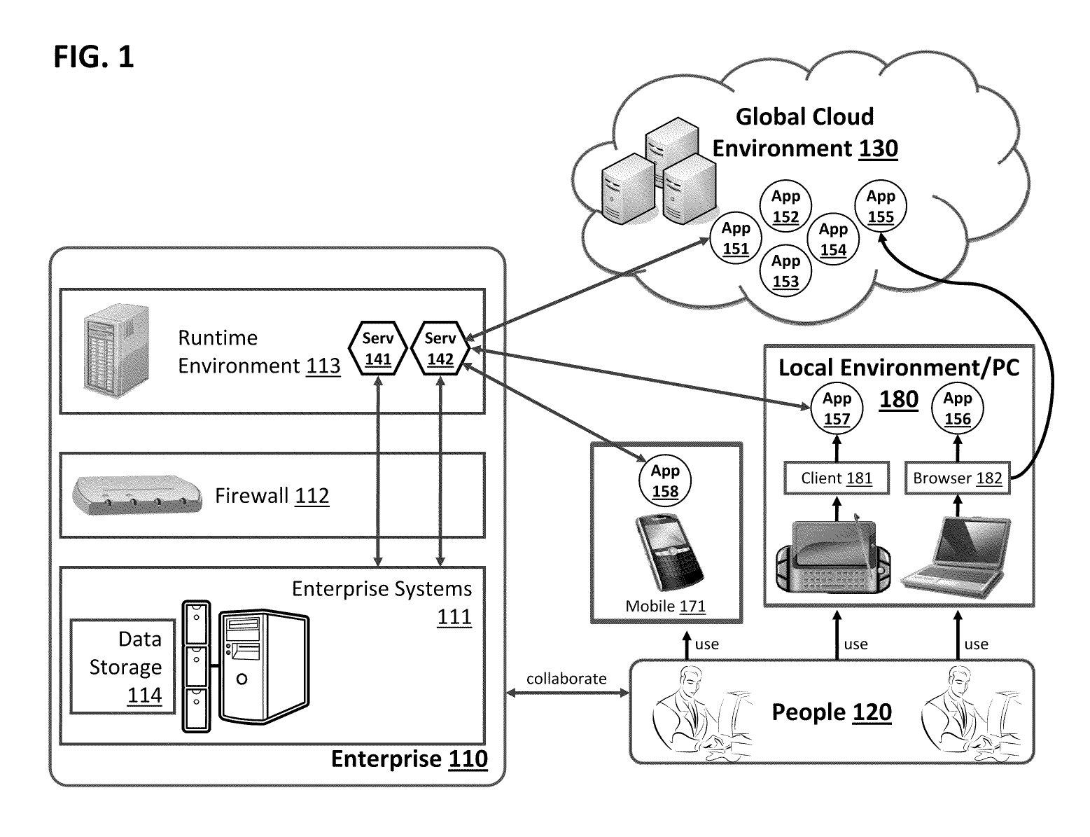

FIG. 1 shows exemplary interactions between networked applications and services in an embodiment of the invention. An enterprise 110 may have one or more enterprise systems 111 for processing organizational data of the enterprise that may be stored in database in data storage system 114. These enterprise systems 111 may process the organization data via e.g. enterprise resource planning programs. Because these systems may manage sensitive and critical information and processes, the systems 111 and 114 may be placed behind a firewall 112 or other security infrastructure to protect the integrity of the processes and data on the enterprise systems 111. On the unsecure side of the firewall 112, the enterprise 110 may create a runtime environment 113 in a different system for executing one or more services 141 and 142.

Each of the services 141 and 142 may contain programming instructions and other code for retrieving, accessing, storing, modifying, and/or manipulating data in the enterprise systems 111 through the firewall 112. Because the services 141 and 142 may access and possibly modify organizational data or processes in the enterprise systems 111, the services 141 and 142 may be written by a provider of the enterprise systems 111 or other sophisticated programmer who is familiar with the security ramifications of including certain functionality in the services 141 and 142. For additional security, the services 141 and 142 may be constrained to function only in the runtime environment 113 in the enterprise 110. By controlling access to the services 141 and 142 in this manner it is possible to minimize the risk of an end user manipulating the services 141 and 142 to perform unauthorized functions in the enterprise systems 111.

Each of the services 141 and 142 may also include programming instructions for restructuring requests from an application running on a standard platform such as Java to a format recognized by the enterprise system 111 in order to access data in the enterprise system 111. In following the representational state transfer (REST) paradigm, services 141 and 142 can be consumed from the outside in a standardized way (through using the HTTP operations for reading or updating data). In addition, the services may support other standard protocols or, if required, also proprietary protocols. However, their main purpose is to serve as an easy to consume interface for applications, which are not directly running on the enterprise system. In supporting open standards, it is possible to implement applications (such as “apps” 151 to 158), which interact with the services, in a variety of technologies (e.g. Java, Ruby on Rails, Adobe Flash, Microsoft Silverlight or the runtime environments of mobile devices).

Each of the apps 151 to 158 may provide a user interface for user interaction with data in the enterprise system 111 obtained through the associated service 141 and/or 142. Apps generally do not have functionality to access data and processes in enterprise systems 111; all of these interactivity functions with data and processes in the enterprise systems 111 may be performed by one or more services, which can be called by the apps.

Information about the services to be called may be set in the configuration of the app or included as part of the underlying source code of the app. This information may provide an address of the runtime environment system 113 and an identifier of the required service(s). To invoke the respective service, a request, such as a HTTP request targeting the service and data and/or an operation to be performed on data in the enterprise system may be sent to the address of the runtime system 113 and service 141 in the URL. The runtime system 113 may parse the request and forward the request to the identified service. The service may then retrieve the identified data or perform the desired operation on the data in the enterprise system and report a result back to the app. The request may also include an identifier of a entity submitting the request, which may include an identifier of the app submitting the request, a user of the app, and/or a system on which the app is running.

Because services generally do not provide user interfaces for subsequent user interaction with the data and processes from the enterprise systems 111, an app may be linked to a service to perform this task. Thus, there may be a tight relationship between apps and services as apps may provide a user interface for user interaction and services may provide the backend interactivity with data/processes in the enterprise systems 111.

Each of the apps may also be developed for different devices using different platforms and protocols, such as Java-based, Adobe Flash-based, and proprietary-based mobile device platforms. Thus app 158 may be developed using a mobile device platform specific to the mobile device 171 on which it will run. App 157 may be developed to run within a client 181 in a local environment 180 and app 156 may be developed to run within a browser 182 in a local environment 180, whereas apps 151 to 155 may be developed to be stored and run in a global cloud environment 130. Each of the apps 151 to 158 may be used by people 120 or other computing processes to access data in the enterprise system 111.

Each app 151 to 158 may also be associated with at least one service 141 and 142. The association may cause the corresponding service to be called when the app is run and may also cause the corresponding app to be triggered when the service is run. The service may trigger a corresponding app through a push notification service or through a link embedded in an email or other communication. An identifier of the apps to be triggered, such as network addresses of devices running the apps, or email or other addresses associated with the apps may be stored in the service, the runtime system 113, the enterprise system 111, or other data source. When the link is activated, either by a person 120 or automatically by a processing device, a notification may be sent to the device running the app or to an email or other address associated with the app to activate the app. The notification may include all necessary information needed for the corresponding app to perform the desired function. If, for example, the desired function is displaying updated data, the notification may include the updated data or an identifier of the updated data to be displayed. Alternatively, services can act as web feeds (e.g. by supporting the RSS or Atom standard) to which people can subscribe. In this case, it's not an e-mail but a new article in the feeds that contains the link. Based on this, a user can activate the respective app as described before.

Each of the apps may be written by third-party software developers who may or may not be affiliated with the enterprise 110 or enterprise system provider. Since the apps may not directly access data or applications in the enterprise system 111, there is less risk that the apps may be manipulated to compromise enterprise systems 111. Thus, the apps 151 to 158 may be distributed to different devices 171 and environments 130 and 180 for people 120 to use.

Because apps may be developed by third parties, including those with no relation to the enterprise or enterprise system provider, a certification program may be used in some embodiments to ensure that apps interfacing with particular services have been inspected for quality control or security purposes. The certification program may be administered by the enterprise, enterprise system provider, or other trusted party.

The certification program may involve the use cryptographic functions, including, but not limited to hash functions, block ciphers, and stream ciphers, to generate credentials. Credentials may include keys, codes, certificates, or ciphers. In some instances, credentials may include unique identification codes assigned to each approved app. The unique identification code may be included in each communication between the app and a corresponding networked service to identify the app. The identification may also be used in some instances to attribute usage and usage fees of a linked networked service to the app. Credentials may be issued by an administrator of the certification program to specific apps that have been approved by the certification authority. For example, the certification authority may only approve apps that pass quality control testing or apps that pass a security screening.

Since networked services may be created by a provider of the enterprise systems or other trusted source and may be directly deployed to a runtime environment of the organization where the services are executed, there may be less opportunities for third parties to directly access or tamper with the networked services. The networked services may thus be considered more secure than the apps, which may be freely deployed to third party systems to be stored and/or executed.

The networked services may therefore include additional security features including access control functionality to prevent non-authorized access to enterprise data. The access control functionality may include access control lists, which may include system or user identifiers indicating the systems and/or users authorized to use the service to interact with the enterprise system. The access control functionality may also specify the data in the enterprise system that an app, system, or user is authorized to access. Access control information may be stored in the service itself or may be obtained from the enterprise system or another system. Access control functionality in the networked service may include credential and/or authentication checks that may involve the use of cryptographic functions for additional security.

Apps 151 to 155 deployed to the global cloud environment 130 may be based on Java and may use servlet containers as a runtime environment. Programmers and developers may locally develop the apps 151 to 155 using open source technology for minimal development costs and then deploy the completed apps 151 to 155 to the global cloud environment 130. Other platforms may also be used in different embodiments.

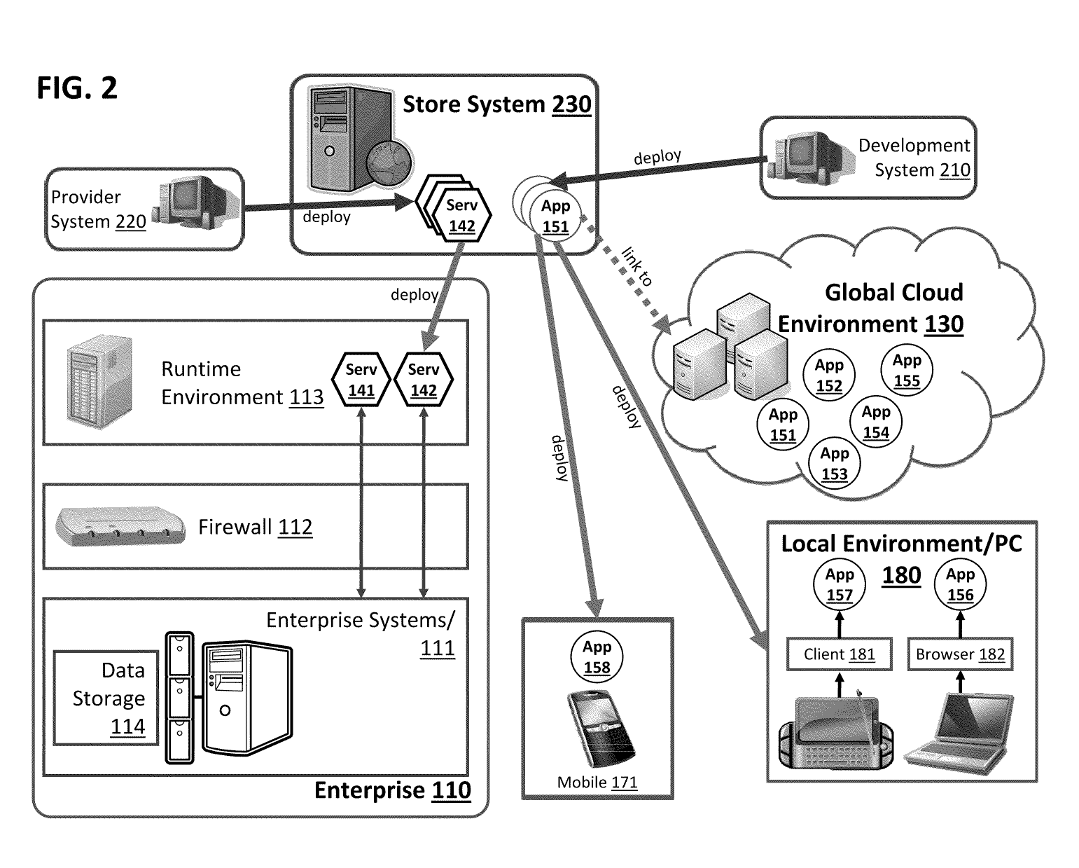

FIG. 2 shows a deployment and distribution plan for deploying and distributing services 141 to 142 and apps 151 to 158. As discussed previously, services 141 to 142 may be created by a provider of an enterprise system 111 or by another source trusted by the enterprise 110 to develop secure services 141 and 142 to interface with the enterprise system 111. Apps may be created by third party developers, by the provider, or by others. Once the provider has finished creating a new service for an enterprise system 111, the provider system 220 may deploy the service 141 to 142 to an ecommerce/store system 230. Similarly, once a developer has completed development of an app 151 to 158, the development system 210 may deploy the app 151 to 158 to the store system 230.

The store system 230 may be an ecommerce computing system where people 120 can view, purchase, and download apps 151 to 158 and individuals in enterprises 110 can view, purchase, and download services 141 and 142 to runtime environment systems 113 of their enterprise 110. The store system 230 may be managed by the provider, enterprise 110, or other entity. The store system 230 may contain program instructions restricting access to services 141 to 142 and apps 151 to 158 to authorized people 120 or enterprises 110. Authorization lookup tables, which may be supplied by the developer, provider, enterprise 110, or other entity, may be used to verify access. The store system 230 may use programming instructions to initiate a scan of requisite applications and/or hardware being used by a prospective purchaser 120. In an embodiment, if a person 120 accesses the store 230 using a mobile device 171, an identifier of the mobile device 171 and the person 120 may be checked against a lookup table to send authorized apps to the mobile device 171 that are compatible with the mobile device 171 and that may be accessed by the person 120.

It is not necessary that people using the apps have individual user accounts on Enterprise System 111, because the Runtime Environment 113 may provide a user mapping. In this user mapping, several persons interacting with the services running on the Runtime Environment 113 can be mapped to the same user account of Enterprise System 111. The respective service 141 then must ensure that only permissible operations are carried out in the Enterprise System 111.

In some instances, developers may deploy completed apps 151 to 155 to systems in a global cloud environment 130 instead of to the store system 230. The store system 230 may contain functionality to link to apps 151 to 155 contained in the global cloud environment systems 130 so that apps deployed to the cloud environment systems 130 may appear in the store as well. The link between the cloud systems 130 and the store system 230 may be updated in real time, such as through push feeds or really simple syndication (RSS) feeds from the cloud systems 130 to the store system 230. The link may also be updated through periodic updates initiated by the store system 230. The ecommerce systems of the store 230 may also include functionality for checking each of the apps 151 and 155 in the cloud systems 130 and only linking to those apps associated with designated services 141 and 142. The designated services may be those services available at the store or the designated services may be supplied through a lookup table. The lookup table may contain data identifying specific apps 151 to 155 in each cloud 130.

Individuals and/or computer programs in an enterprise 110 may search the store system 230 for new or updated services that are not included in the runtime environment systems 113 but may be desirable or necessary to run certain apps. Once these services have been identified, such as service 141, they may be downloaded or deployed to the runtime environment systems 113 of the enterprise 110.

Additionally, store system 230 may also include functionality for enterprise system users and others to post feedback, request implementation of specific apps and services, vote on apps and services for development, and other collaborative features. This functionality may enable the store system 230 to bring different parties together, including enterprise system users, networked services developers, app providers, and app users, to provide feedback, share ideas, and generate new apps and/or networked services.

A centralized store system 230 may be used in some instances to showcase all networked services offered by a networked services provider. Thus, if the networked services provider is also the developer of the enterprise computing systems used by an organization, the centralized store may be used by the organization to search, browse, or otherwise identify particular networked services to be added-on to the organization's enterprise computing system to offer additional functionality. The identified networked services may then be downloaded directly to the organization's systems.

In some instances, an identifier may be embedded in the networked services selected for download prior to the downloading. The embedded identifier may then be later used to identify an entity responsible for the usage fees associated with the use of the downloaded networked services. In other instances the responsible entity may be identified after the networked services are downloaded.

People 120 and/or computer programs running in local environment systems 180 or on other devices, such as mobile device 171, may search the store 230 for new or updated apps 151 to 158. Once a desired app has been identified, the app may be downloaded or deployed to a local environment system 180 or device. The app may then be executed from a local environment system 180 or device and interface with the corresponding service executed from the runtime environment system 113 to access data in the enterprise system 111 through data storage 114. Thus, once the corresponding service has been deployed to the runtime environment system 113 of enterprise 110 and app has been deployed to a local environment system 180, device 171, or other computing system, the app and corresponding service may interact directly with each other through their respective environments and bypass the store system 230 altogether at runtime.

In order to ensure integrity of the relationship between apps and services, the provider may certify individual apps and/or developers/companies providing apps. On the store, certification may be made visible to people, so that they filter e.g. for certified apps.

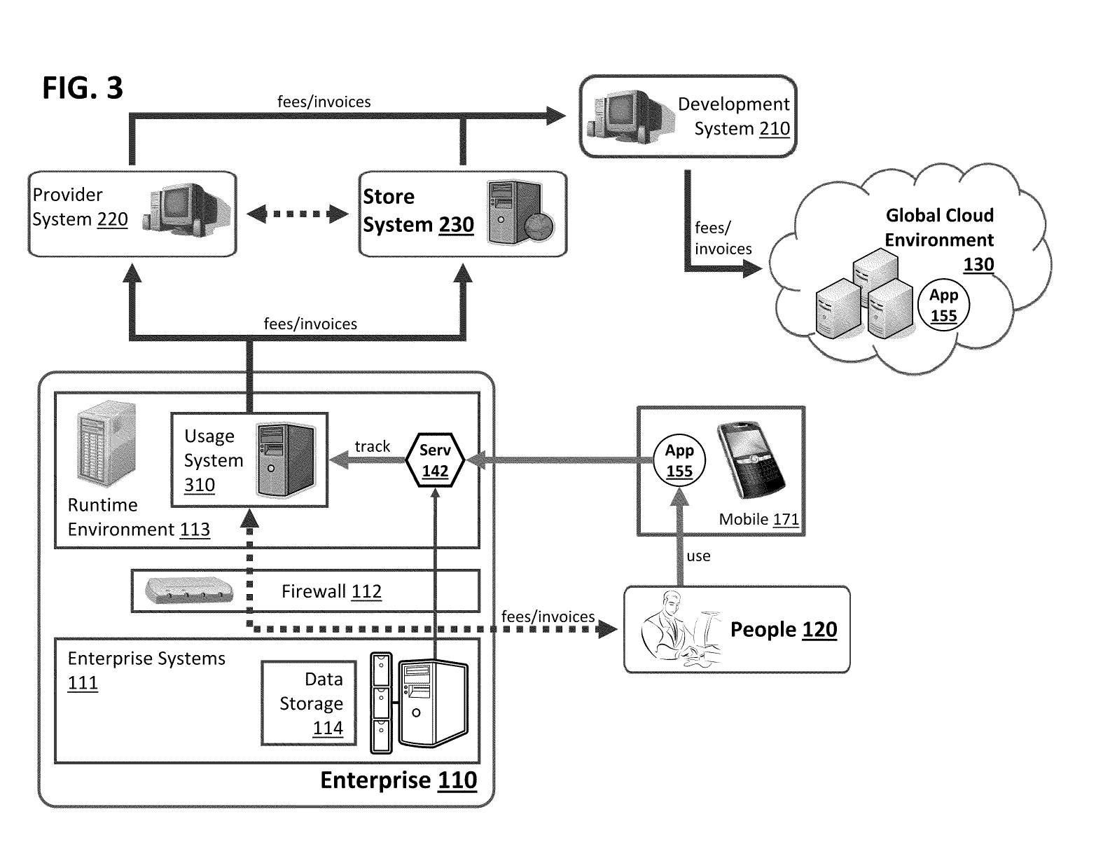

FIG. 3 shows an exemplary monetization plan for generating revenue based on actual use of services 141 and 142 and/or apps 151 to 158. Each networked service 141 to 142 may include instructions to record each instance that the service is called or executed in a usage system 310. In addition to recording each of these instances, a service may also include instructions to record a date/time that the service was executed, an identifier of app, such as app 155 that invoked the service or was triggered by the service, and an identifier of a person 120 causing the service to be executed, either directly or indirectly through an app. The identifiers of the person 120 may be obtained by the app 155 from the local environment on which the app is running. Alternatively, the identifier of the person 120 may be supplied by the person 120 or the system on which the app is being executed at runtime.

In some embodiments, a service may also include instructions for verifying the validity of the person identifier against existing data stored in the enterprise system 111. The person identifier may be used in some embodiments to charge certain persons 120 using the app a usage fee based on their recorded usage of a particular service and/or app. In some embodiments where the person using the app and/or service is not assessed a usage fee, the service may not record an identifier of the person.

The aforementioned information recorded by a service may be recorded in databases or other data structures of a usage system 310. In some embodiments, the usage system 310 may operate within runtime environment system 113, though in other embodiments the usage system 310 may operate outside the runtime environment system 113. In some embodiments, the usage system 310 may be operated at or in conjunction with the store system 230, provider system 220, developer system 210, cloud environment systems 130, or in other systems.

The recorded information may be used to assess a usage fee for the services and/or apps used the by the enterprise in a given period. The usage fee may vary depending on the service or app used, the number of uses of the service or app, the amount of data that was retrieved from the enterprise system through the service or app for a specific user request or on other factors. A quantitative network service usage algorithm may be used to calculate the usage fees based the tracked usage of the networked service.

Invoices may be generated from the events recorded in usage system 310 based on the specific fee agreements reached between the parties. For example, a fee agreement may require an enterprise 110 to pay a provider of service 142, X per use of service 142, and pay a developer of app 155, Y per use of service 142 through app 155. Thus, if a person uses app 155, which may be linked to service 142, the enterprise will have pay (X+Y) per use of the app. In this example, the quantitative network service usage algorithm in the case of app 155 may be (X+Y)*(the number of invocations of the service 142), though in other embodiments the algorithm may vary.

A calculating arrangement may be included as part of a usage tracking system to track different usage properties of networked services and then apply the quantitative networked service usage algorithm to calculate a usage fee. For example, the calculating arrangement may track the number of invocations of a networked service, an aggregate time spent executing a networked service, or an aggregate quantity of data transmitted as a result of using the networked service. These tracked quantities may then be used as inputs to the quantitative usage algorithm to calculate a total use or use fee for the networked service. Such calculations may be performed automatically by the usage system 310 to calculate fees, generate invoices, and/or direct remittance of use fees.

In an embodiment, the terms of the fee agreement may be stored in a database and linked to data in the usage system 310 to automatically generate periodic invoices. The invoices may be generated by any party, including the developer, provider, enterprise, store, or another party. If the enterprise generates the invoices, the usage system 310 may also automatically instruct payments to be sent to one or more of the parties to the fee agreement. In one embodiment, the enterprise may remit the (X+Y) payment to the provider system 220, for example, and the provider system 220 may keep X and then remit Y to the developer system 210. The developer system 210 may in turn remit payment Z to another entity's system, which may represent a fee for the developer's use of the store system 230 and/or cloud environment systems 130 hosting the app 155.

In another embodiment, other party systems, such as the provider system 220 or the store system 230, may be responsible for managing invoice and payments. In this situation, the usage system 310 may still be maintained by the enterprise 110 or it may be hosted and maintained by other parties. If the party hosting and maintaining the usage system 310, such as the enterprise 110, is different from the party responsible for managing invoices and payments, the party responsible for managing invoices and payments may receive periodic updates from the usage system 310. These updates may be supplied through push services, such as HTTP server pushes or Java pushlets, or pull services, such as RSS feeds.

The computing systems of the party responsible for managing invoices and payments may then automatically generate and send invoices to those responsible in the fee agreements for paying usage fees for the services and apps used. These computing systems may also send instructions to remit payments to those entities entitled to receive payments according the fee agreement based on the data recorded in the usage system 310.

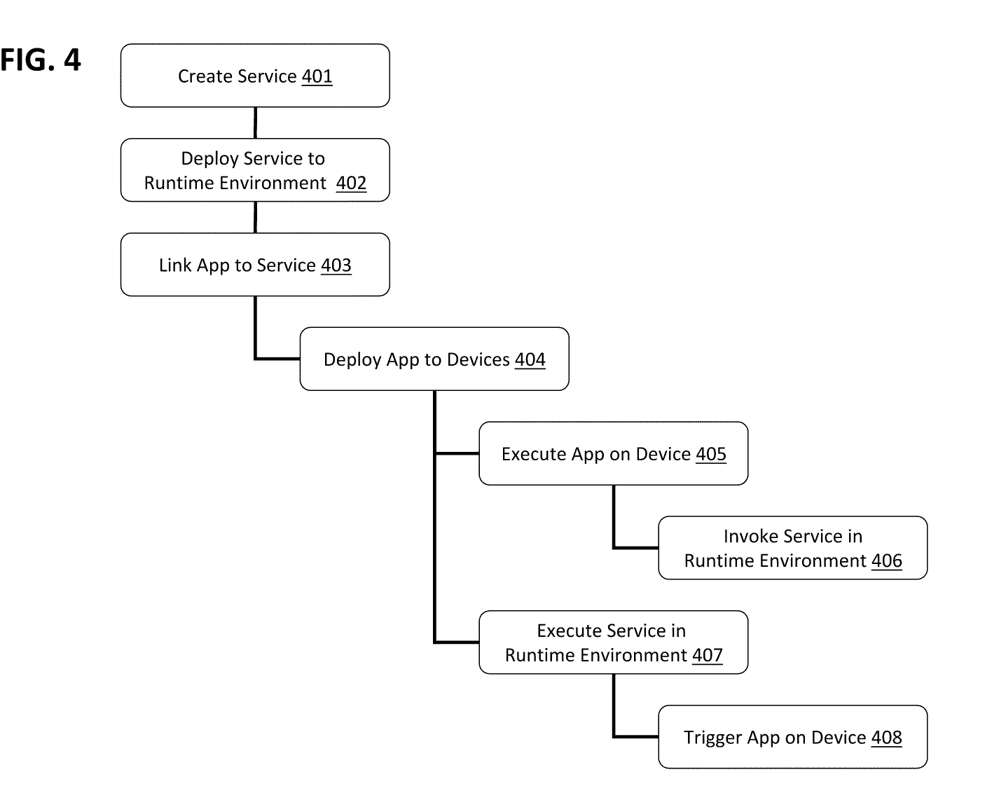

FIG. 4 shows an exemplary method for deploying and using services and apps in an embodiment. In box 401, a service may be created and published by a provider of enterprise systems or other entity trusted to develop programs directly interfacing with an organization's enterprise systems. The service may provide new interactivity with data in an enterprise systems. The service may include new platforms and/or protocols for apps to use data accessed through the service. The service may be published by posting the app in an ecommerce store system 230. The service may also be published through other dissemination techniques, such as electronically informing enterprises of the availability of the service. Publication of the service may also be restricted to specific enterprises selected by the provider or other parties.

Once the service has been created and/or published, in box 402, the service may be deployed to the runtime environment system of an enterprise intending to use the service. The service may be deployed electronically through secure or unsecure protocols via push or pull technologies. In some instances, an entity, such as a system administrator, in the enterprise may select specific services to be implemented in the runtime environment system, which may then be downloaded and automatically implemented in the runtime environment unless further configuration is required. In other instances, a provider, store, or other entity may want to push updates or critical services to the runtime environment of enterprise automatically through push technologies, such as HTTP server push, Extensible Messaging and Presence Protocol (XMPP), and long polling. The services that are pushed out may also be automatically implemented in the runtime environment in some instances.

In box 403, an app with a user interface for presenting specific data in an enterprise system may be linked to a corresponding service interfacing with the enterprise system to access the specific data. Similarly, a service that is designed to interface with different apps for different systems, such as different mobile computing platforms, may be linked to each of the different apps.

In box 404, the app may be deployed to a device. The app may be deployed electronically through secure or unsecure protocols via push or pull technologies. In some instances, a user of the device may select specific apps from a store system 230, cloud systems 130, or other source systems to be deployed and executed on the device. In some instances, the app may be downloaded and automatically configured to be subsequently executed on the device. In other instances, a provider system, store system, or other entity system may want to push updates or critical apps to the device automatically through push technologies. The apps that may be presented to a user for possible deployment may be limited in some instances to those that are compatible with the device and/or that the user is authorized to access. Since apps provide user interfaces for interfacing with data provided by a linked service, each app may only be operative to provide user interfaces on a specific device platform. Thus in some instances there may be many versions of the same app that may be designed to perform the same functions on different device platforms.

In box 405, an app on a device may be executed. Executing the app on the device may eventually result in data being sent to the corresponding service linked to the app in box 403.

In box 406, the linked service in the runtime environment may be invoked, in some instances using data supplied by the app. Invoking the service may cause the service to retrieve, save, and/or manipulate data from the enterprise system and sent a result back to the app.

In box 407, a service may be executed in a runtime environment. The execution of the service may cause the service to interact with data in the enterprise system and report a result of the interaction to an app linked to the service in 403. In some embodiments, the service may report the result to all apps linked to the service and in other instances the service may report the result to a subset of apps linked to the service depending on the configuration of the service.

In box 408, the app on a device may be triggered by the service in order to report the result to the app. Triggering the app may cause the app to be executed on a device. Alternatively, triggering the app may also cause the app to be updated with the result so that the next time the app is executed on the device, the result will be available on the device. Triggering the app may also cause the app to generate an alert or reminder. After receiving the reminder, the user of the device may execute the app in box 405 to invoke the service in box 406 and retrieve the result through the service.

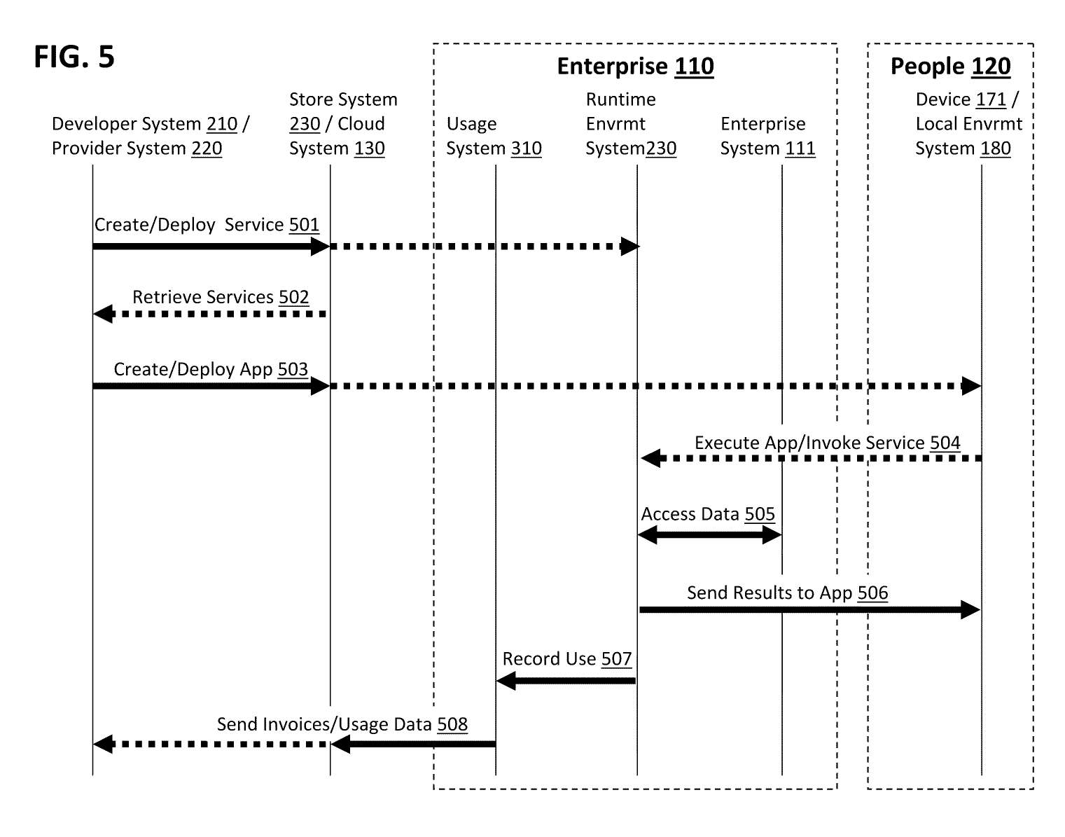

FIG. 5 shows an exemplary flow of data between systems in an embodiment. Once a provider has created a service, the created service may be deployed 501 from a provider system 220 to an ecommerce/store system 230 or other systems that are part of a cloud environment 130. An administrator in an enterprise 110 looking for additional functionality in one or more services may search the ecommerce system 230 or cloud systems 130 to find the service offering the requisite functionality. Once the administrator finds the service, the service may be selected and automatically deployed to the runtime environment system 230 of the enterprise 110. Alternatively, instead of searching ecommerce system 230 or cloud systems 130, a new service may be deployed to the runtime environment system 230 directly from the provider system 220.

A developer seeking to develop an app may search available services in the ecommerce system 230 or cloud systems 130 to identify one or more services providing the functionality and interfaces to the enterprise system 111 that are most closely aligned with the objectives of the app. One or more elements of these identified services may then be retrieved 502 from these systems 230 and 130 and copied to the developer system 210 where the developer can design an app to interface with the retrieved 502 elements of the service. In some instances, copies of the actual services may not retrieved; instead copies of instructions for interfacing with service, such as the structure of specific HTTP post commands or SOAP remote procedure calls (RPC) may be retrieved 502 in lieu of the actual service.

Once the developer completes the app and links the app to at least one service, the app may be transferred from the developer system 210 to the ecommerce system 230 and/or cloud systems 130. A person 120 may then search these systems 230 and 130 from a device 171 or a system in a local environment 180 to find a desired app. Once the desired app is identified, the app may be deployed 530 from the ecommerce system 230 and/or cloud systems 130 to the device 171 or system in the local environment 180. Alternatively, the app may be deployed 503 directly from the developer system 210 to a device 171 or system in a local environment 180.

Once the app is executed 504 in the device 171 or local environment 180, the executed app may invoke 504 a service in the runtime environment system 113 of the enterprise 110. The invocation 504 of the service may cause the service in the runtime environment system 113 to access data in the enterprise system 111 of the enterprise 110. A push mode service may also access data 505 in the enterprise system 111 without being invoked 504 by an app if the service is so configured. Accessing data may include reading, writing, manipulating, transforming, or altering data.

Once the service has accessed the appropriate data in the enterprise system 111, the service may send a result 506 of the data access from the runtime environment system to the app on the device 171/local environment 180.

The service may also record 507 usage information in a usage system 310, such as an identifier of: the service, an app invoking the service or to which results of the data access were sent, a person 120 using the app, the data accessed in the enterprise system 111, a quantity of data accessed in the enterprise system 111, and a date/time the service was used. The usage information may be recorded in a table, database, or log in the usage system 310, which may or may not be managed by the enterprise 110.

Usage information may be sent 508 periodically or in real time to the ecommerce 230/cloud 130 systems. In some embodiments, the ecommerce 230/cloud 130 system may periodically or in real time send 508 usage information to developer 210 and/or provider 220 systems.

In some embodiments, instead of sending usage data 508 to these systems, the usage system 310 may generate invoices from the recorded usage information and send the invoices to the other systems 130, 210, 220, and/or 230. The usage system 310 may also generate and send invoices to identified people 120 using apps associated with particular services based on the person's 120 usage of the app and/or service in accordance with terms of a usage agreement. The usage system 310 may also cause payments to be remitted to these systems depending the recorded usage information of the services and the terms of any usage agreements.

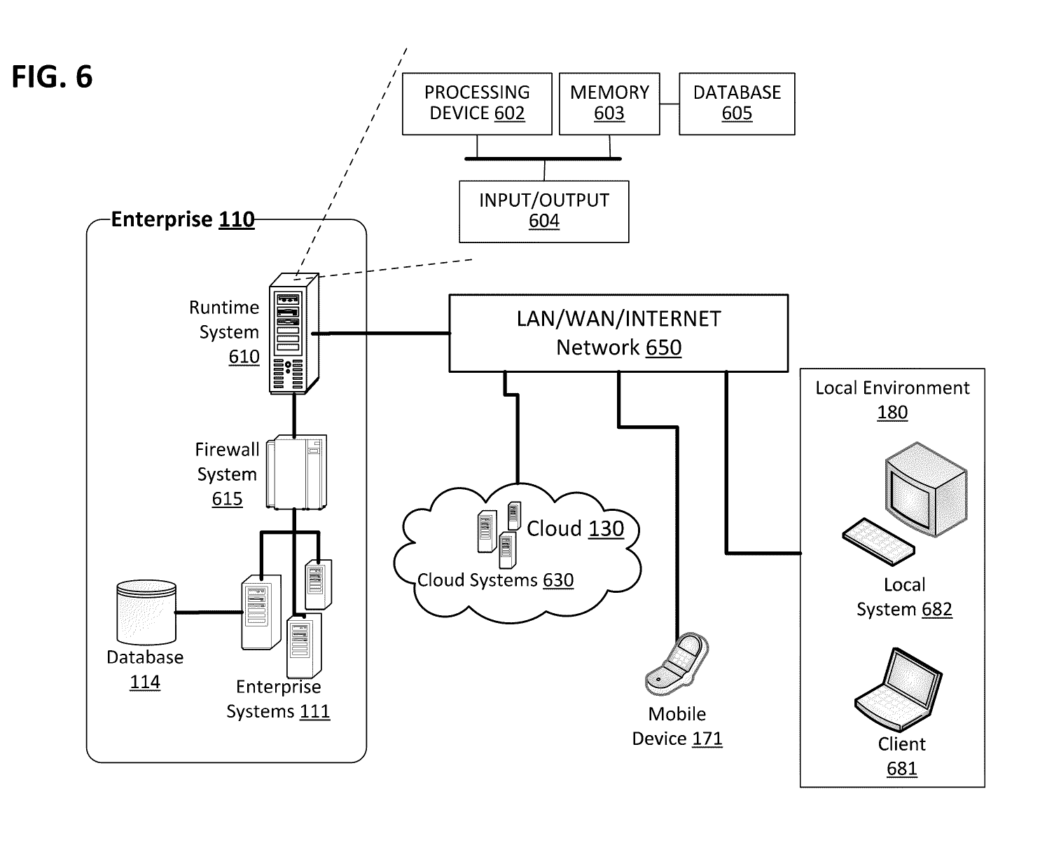

FIG. 6 shows an exemplary architecture of systems in an embodiment of the invention.

Runtime system 610, which may create and manage runtime environment 130, may be connected to firewall system 615 and network 650. Network 650 may include a LAN, WAN, VPN, or the Internet. Mobile device 171, the local systems 682 and clients 681 in local environment 180, and the cloud systems 630 in the cloud environment 130 may also be connected to the network 650. The firewall system 615 may also be connected to the enterprise systems 111 and may provide an additional layer of security for enterprise systems 111 by preventing unauthorized access to these systems 111.

Each of the systems, clients, and devices in FIG. 6 may contain a processing device 602, memory 603 containing a database 605, and an communications device 604, all of which may be interconnected via a system bus. In various embodiments, each of the systems 111, 171, 610, 615, 630, 681, and 682 may have an architecture with modular hardware and/or software systems that include additional and/or different systems communicating through one or more networks. The modular design may enable a business to add, exchange, and upgrade systems, including using systems from different vendors in some embodiments. Because of the highly customized nature of these systems, different embodiments may have different types, quantities, and configurations of systems depending on the environment and organizational demands.

Communications device 604 may enable connectivity between the processing devices 602 in each of the systems and the network 650 by encoding data to be sent from the processing device 602 to another system over the network 650 and decoding data received from another system over the network 650 for the processing device 602.

In an embodiment, memory 603 may contain different components for retrieving, presenting, changing, and saving data. Memory 603 may include a variety of memory devices, for example, Dynamic Random Access Memory (DRAM), Static RAM (SRAM), flash memory, cache memory, and other memory devices. Additionally, for example, memory 603 and processing device(s) 602 may be distributed across several different computers that collectively comprise a system.

Processing device 602 may perform computation and control functions of a system and comprises a suitable central processing unit (CPU). Processing device 602 may comprise a single integrated circuit, such as a microprocessing device, or may comprise any suitable number of integrated circuit devices and/or circuit boards working in cooperation to accomplish the functions of a processing device. Processing device 602 may execute computer programs, such as object-oriented computer programs, within memory 603.

Third party development of different apps may allow organizations to develop customized apps with minimal resources. Software development projects that may not have been a priority for an organization with limited resources, or may have been too complex or expensive to justify may be reevaluated given the lower development costs associated with app development. Part of these lower development costs may be attributed to the ability of developers to use almost any development platform supporting a representational state transfer paradigm compatible with respective networked services. Since the networked services provide an interface to access data in the enterprise computing system, app developers do not necessarily need in-depth knowledge of the functionality and architecture of the enterprise computing system and may focus their attention on the design and development of the app user interface.

Two exemplary app development scenarios are discussed below. Although these examples describe the use of apps to transmit medical information and electricity consumption data, other apps may be developed to exchange other types of information in different contexts.

In some workplaces employees may be required to present a doctor's note to be eligible for certain types of sick leave. The doctor's note may be required to confirm eligibility for certain types of sick leave and may be required to be submitted to both the employer and an insurer. Typically, a medical secretary may type the contents of the doctor's note into an application, print out copies of the note, and provide the employee with copies of the note. The employee may then send the letter to the employer and either the employee or the medical secretary may send a second copy to the insurer. The employer and the insurer may then transfer the contents of the note into their respective computer systems for further processing.

Although there are several inefficiencies associated with this process, such as the re-entry of the printed note contents into the respective computer systems, delays and risk of loss in sending the printed notes to the insurer and employer, and the potential of fraud by the employee in altering the contents of the printed note, the cost of developing an application integrated into the insurer's and/or employer's enterprise computing systems may have exceeded the potential cost savings from efficiency improvements.

However, with networked services and apps, once a networked service is developed enabling the exchange of pertinent data with the specific systems of an organization, the networked service may be used to facilitate the transfer of pertinent data between systems. Thus, an app developer, such as a third party developer familiar with developing applications for the platform used by the medical secretary would need to develop an app for the medical secretary to enter the pertinent patent and medical diagnosis information, which may then be electronically transfer into the computing systems of the insurer and/or employer through the networked service.

Each of the RESTful networked services may be designed for particular enterprise computing systems. If the employer and insurer use the same enterprise computing systems, then it is possible that the same networked service may be used by both. However, if they use different enterprise computing systems, then each may use its own networked service to enable the transfer of the data from the medical secretary into the respective enterprise computing system.

An app store may be used to distribute app to the medical secretaries and others wanting to use the app. Since different medical providers may using different computing systems and platforms, the app store may provide a central repository for the providers to download particular apps designed for their computing systems and platforms.

Additionally, since the cost of developing an app is much lower than developing a complete application integrated into an enterprise computing system, this model may provide additional value for business using enterprise computing systems.

As a second example, some utility companies may ask their customers to self-record current utility meter data and send in the data via mail. Alternatively, utility companies may use meter readers to physically check and validate meter data. Both of these inefficient processes may be simplified by using an app to transfer current meter data to the utility company through a networked service over a communications network, such as the Internet.

In a first development phase, a utility may procure development of a first cloud-based app for customers or meter readers to upload their usage data to the utility company through a linked RESTful networked service from a device connected to a communications network, such as the Internet. If no such RESTful networked service exists to the integrate the uploaded data into the enterprise computing system of the utility company, the utility company may procure development of the networked service from the enterprise computing system provider. Although the costs for developing networked services may require special skill sets, such as in-depth knowledge of the architecture of the enterprise computing system, and may also require additional resources and costs over the development of apps, each service may be used with multiple apps resulting in a relatively low cost per use for versatile services. The first development phase implementation may save the utility the expense of transferring the mailed and other collected meter reading data into its enterprise computing system.

Later, if the utility decides to implement smart meters at customer sites, the utility may procure development of a second app in a second development phase. The second app may automatically transfer meter data from the smart meter to the utility through a communications network, such as the Internet, and a linked networked service. This second app may greatly reduce the utility's meter reading expenses associated with manual meter readers and manual meter data collection.

The second app may be linked to the same networked service in the above first example since the same type of data may be integrated into the utility's enterprise computing system. Thus, the only added cost for the utility for including this new functionality is the cost associated with developing and deploying the new app. Moreover, since apps are independent of the utility's enterprise computing system and networked services interfacing with these systems, new apps may be readily developed for any platform supporting RESTful compliant connectivity with its associated networked service, including future platforms that may be developed to support newer smart meters.

The development expenses associated with the second phase new app development may be much lower than the first phase if the same networked service may be reused. Moreover, since app development is generally less complicated than networked services development, new apps can be developed and deployed fairly quickly, leading to improved turnaround times. Such functionality may make it easier for organizations to quickly develop and deploy new computing functionality to customers and business partners at lower costs.

The foregoing description has been presented for purposes of illustration and description. It is not exhaustive and does not limit embodiments of the invention to the precise forms disclosed. Modifications and variations are possible in light of the above teachings or may be acquired from the practicing embodiments consistent with the invention. For example, some of the described embodiments may include software and hardware, but some systems and methods consistent with the present invention may be implemented in software or hardware alone. Additionally, although aspects of the present invention are described as being stored in memory, this may include other computer readable media, such as secondary storage devices, for example, hard disks, floppy disks, or CD ROM; the Internet or other propagation medium; or other forms of RAM or ROM.

We claim:

1. A method comprising:
parsing through a processing device in a runtime environment system a plurality of HTTP requests received from a plurality of apps executed on a plurality remote systems running on different platforms, each app being specific to the platform of its remote system and generating a user interface in its remote system for interacting with data in an enterprise system, the parsing identifying a service linked to the app, the app, and the data in each request;
executing the identified service in each request through the processing device to access the respective identified data in the enterprise system and report a result of the access to the app;
recording an identifier of each executed service and each app linked to the executed service in a usage system; and
generating an invoice including a usage fee for at least one service and at least one app calculated from the identifiers recorded in the usage system.

2. The method of claim 1, further comprising recording an identifier of a user responsible for initiating the execution of the identified service.

3. The method of claim 2, further comprising causing the generated invoice to be sent the user.

4. The method of claim 1, wherein the data in the enterprise system is within a secure side of a firewall system and a runtime environment for executing each service is within an unsecure side of the firewall system.

5. The method of claim 4, wherein each service functions exclusively in the runtime environment.

6. The method of claim 1, wherein each service includes programming instructions to restructure commands from a first platform format to a second platform format.

7. The method of claim 6, wherein the first platform format is Java and the second platform format is a format recognized by the enterprise system.

8. The method of claim 6, wherein the first platform format is a mobile device compatible format and the second platform format is a format compatible with the enterprise system.

9. The method of claim 1, wherein the accessing and processing of the data in the enterprise system is performed by each service, the apps configured to interact with the data indirectly through its identified service.

10. The method of claim 1, wherein different apps in the plurality of apps support different devices having different remote system platforms, at least two of the different apps interfacing with a same set of data in the enterprise system through a same service.

11. The method of claim 10, wherein a first app of the different apps supports a Java device and a second app of the different apps supports an Abode Flash device.

12. The method of claim 1, wherein at least one app causes the identified service to be executed when the app is run.

13. The method of claim 1, wherein at least one identified service causes its linked app to be triggered when the service the run.

14. The method of claim 13, wherein the linked app is triggered through a push service.

15. The method of claim 1, wherein the apps are deployed to and obtained from a cloud environment.

16. The method of claim 1, wherein the services are deployed to and obtained from an ecommerce store system.

17. The method of claim 16, wherein the ecommerce store system includes an access control to restrict access to at least one service.

18. The method of claim 1, further comprising applying an algorithm based on recorded terms of a fee agreement and at least one of the recorded identifiers to calculate the usage fee.

19. A computer readable memory device comprising instructions that, when executed by a processing device, cause the processing device to:
parse in a runtime environment system a plurality of HTTP requests received from a plurality of apps executed on a plurality remote systems running on different platforms, each app being specific to the platform of its remote system and generating a user interface in its remote system for interacting with data in an enterprise system, the parsing identifying a service linked to the app, the app, and the data in each request;
execute the identified service in each request through the processing device to access the respective identified data in the enterprise system and report a result of the access to the app;
record an identifier of each executed service and each app linked to the executed service in a usage system; and
generate an invoice including a usage fee for at least one service and at least one app calculated from the identifiers recorded in the usage system.

20. A system comprising:
an enterprise system storing data coupled to a secure side of a firewall system;
a runtime environment system coupled to an unsecure side of the firewall system and a communications network, the runtime system configured to:
parse a plurality of HTTP requests received over the communications network from a plurality of apps executed on a plurality remote systems running on different platforms, each app being specific to the platform of its remote system and generating a user interface in its remote system for interacting with data in an enterprise system, the parsing identifying a service linked to the app, the app, and the data in each request;
execute the identified service in each request through the processing device to access the respective identified data in the enterprise system and report a result of the access to the app;
record an identifier of each executed service and each app linked to the executed service in a usage system; and
generate an invoice including a usage fee for at least one service and at least one app calculated from the identifiers recorded in the usage system.
